(19) United States
(12) Patent Application Publication
(10) Pub. No.: US 2017/0199607 A1
(43) Pub. Date: Jul. 13, 2017

(54) DISPLAY DEVICE WITH TOUCH PANEL

(71) Applicant: MITSUBISHI ELECTRIC CORPORATION, Tokyo (JP)

(72) Inventor: Hiroyuki NAKANO, Tokyo (JP)

(73) Assignee: MITSUBISHI ELECTRIC CORPORATION, Tokyo (JP)

(21) Appl. No.: 15/397,128

(22) Filed: Jan. 3, 2017

(30) Foreign Application Priority Data
Jan. 13, 2016 (JP) 2016-004050

(51) Int. Cl. G06F 3/041; G02F 1/1333

(52) U.S. Cl. CPC G06F 3/0412; G02F 1/13338; G06F 2203/04107; G06F 2203/04103

(57) ABSTRACT

A display device with a touch panel includes: a display device that has a display surface on which an image is displayed; a touch panel that is disposed at a position corresponding to the display surface; a protective plate that has light translucency and is provided with a printing portion at a peripheral part thereof to protect the touch panel; and a transparent resin that has light translucency and is disposed in a gap between the touch panel and the protective plate to bond the touch panel and the protective plate to each other, wherein the touch panel extends to a position overlapping the printing portion of the protective plate in plan view, and includes a bonding member that fixes the display device and the touch panel to each other at a position overlapping the printing portion.

### CROSS-REFERENCE TO RELATED APPLICATION

This application claims priority from Japanese Patent Application No. 2016-004050 filed on Jan. 13, 2016, the entire subject matter of which is incorporated herein by reference.

### TECHNICAL FIELD

This disclosure relates to a display device with a touch panel.

### BACKGROUND

In a display device with a touch panel for outdoor installation, for example, a touch panel-equipped liquid crystal display device using a liquid crystal, in order to protect from external impact and flooding due to rainfall, a transparent protective plate made of resin or glass covers a front surface of a touch panel, and a peripheral part of the protective plate may be subjected to waterproofing.

In a display device with a touch panel disclosed in JP-A-2014-106425, decorative printing is performed on a periphery of a back surface of a protective plate, a bonding member is disposed corresponding to the decorative printing portion, and the protective plate is bonded to a housing or a touch panel using the bonding member.

### SUMMARY

When the display device with the touch panel described above is exposed to ultraviolet light for a long time in outdoors or the like, the decorative printing portion formed on the back surface of the protective plate deteriorates. Therefore, the bonding member on which the deteriorated decorative printing portion is disposed may be peeled off.

This disclosure is to provide a display device with a touch panel having a protective plate in which even when a decorative printing portion is formed on a periphery of a back surface of the protective plate and then a bonding member is disposed to fix other members to each other, the bonding member is suppressed from being affected by ultraviolet light or the like and can achieve long-term bonding strength.

A display device with a touch panel according to this disclosure includes: a display device that has a display surface on which an image is displayed; a touch panel that is disposed at a position corresponding to the display surface; a protective plate that has light translucency and is provided with a printing portion at a peripheral part thereof to protect the touch panel; and a transparent resin that has light translucency and is disposed in a gap between the touch panel and the protective plate to bond the touch panel and the protective plate to each other, wherein the touch panel extends to a position overlapping the printing portion of the protective plate in plan view, and includes a bonding member that fixes the display device and the touch panel to each other at a position overlapping the printing portion.

In the display device with the touch panel according to this disclosure, even when the decorative printing portion is formed on the periphery of the back surface of the protective plate and then the bonding member is disposed to fix other members to each other, the bonding member is suppressed from being affected by ultraviolet light or the like and can achieve long-term bonding strength.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a plan view of a display device with a touch panel according to this disclosure;

FIG. 2 is a cross-sectional view taken along line A-A in FIG. 1; and

FIG. 3 is a cross-sectional view of a display device with a touch panel according to a modified example of this disclosure.

### DETAILED DESCRIPTION

Applicable embodiment of this disclosure will be described below with reference to the accompanying drawings. The following description is intended to explain the embodiments of this disclosure, and this disclosure is not limited to the following embodiments. In the drawings, the same components are denoted by the same reference numerals, and the description thereof will not be presented.

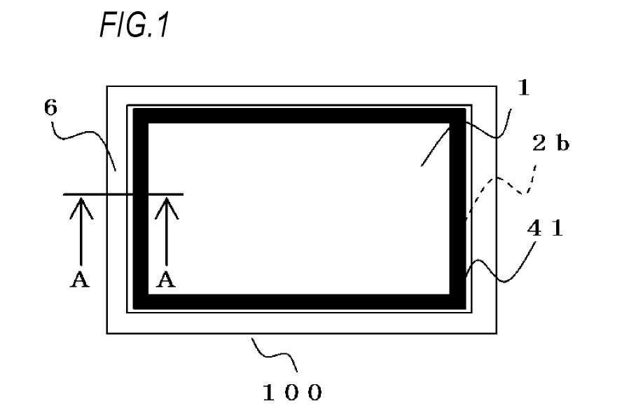

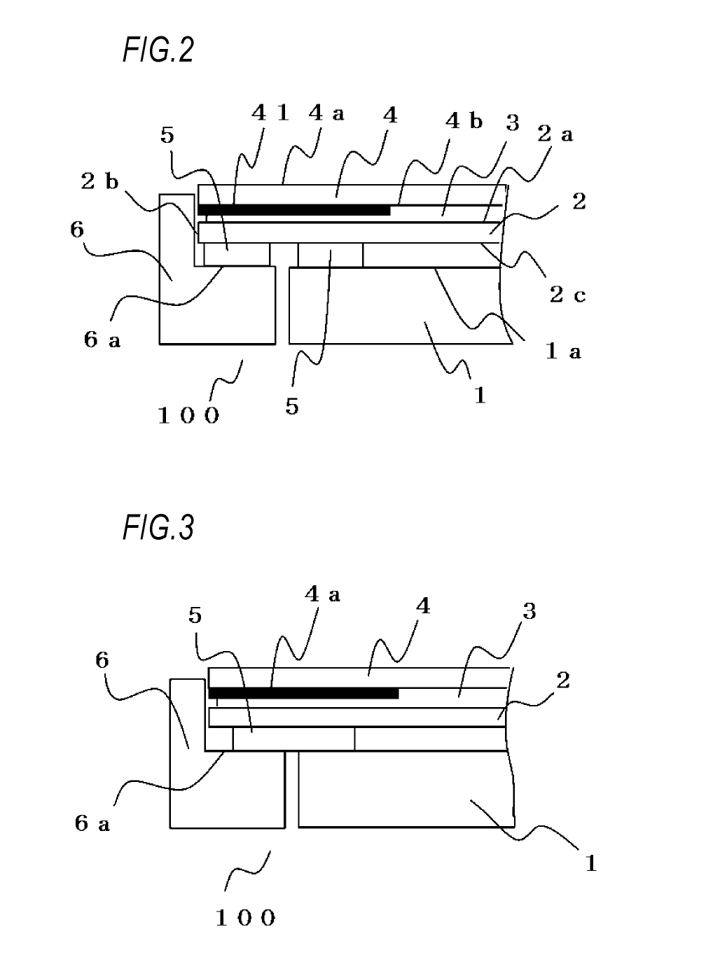

FIG. 1 is a plan view of a display device with a touch panel according to this disclosure, and FIG. 2 is a cross-sectional view taken along line A-A in FIG. 1.

As illustrated in FIGS. 1 and 2, a display device with a touch panel 100 according to this disclosure is configured to include a display device 1 having a display surface 1a (an upper side in the paper space) that displays an image, a touch panel 2 that is disposed on the display surface 1a of the display device 1, a protective plate 4 that protects a front surface 2a (an upper side of the paper space) of the touch panel 2, a transparent resin 3 that is disposed in a gap between the touch panel 2 and the protective plate 4, a bonding member 5 that fixes the touch panel 2 and the display device 1 to each other, and a bonding member 5 that fixes the touch panel 2 and a housing 6 to each other.

The display device 1 can employ a liquid crystal display panel applying double refraction of a liquid crystal material or a display panel such as a display plate in which a character or a picture is printed on a transparent plate. The liquid crystal display panel includes a color filter substrate, on which a color filter and a light shielding layer are formed, and a thin film transistor (referred to as TFT hereinafter) substrate on which a TFT serving as a switching element and a pixel electrode are formed, the color filter substrate and the TFT substrate being disposed to face each other. The liquid crystal display panel further includes a spacer for holding a gap between both substrates, a sealing material for bonding the color filter substrate and the TFT substrate to each other, an alignment film including a liquid crystal material sandwiched between the color filter substrate and the TFT substrate and aligning a liquid crystal, and a polarizing plate. The liquid crystal display panel controls alignment of a liquid crystal layer by turning a voltage on or off by the switching element, and modulates light incident on the liquid crystal display panel according to a video signal, thereby performing display. In addition, the display panel holds a light source device that irradiates light. The light source device includes a light source, a light guide plate that emits light emitted from the light source in a plane shape, an optical sheet that is disposed on a light emission surface of the light guide plate to diffuse and control the light of the light guide plate, a reflection sheet that is disposed on an opposite light emission surface of the light guide plate to allow light emitted from the light guide plate to be incident on the light guide plate again, and a rear frame that holds these members (all of them are not illustrated).

In the touch panel 2 used in this embodiment, counter electrodes are formed between the substrates, and thus the touch panel 2 is driven by reaction of the electrode at a touched position. For example, an electrostatic capacity type touch panel or a resistance film type touch panel is used as the touch panel 2, but any type of touch panel may be uses as the touch panel 2 in this embodiment.

The protective plate 4 is provided to cover the front surface 2a of the touch panel 2, and protects the front surface 2a of the touch panel 2. The protective plate 4 may be made of a material having light translucency, for example, an insulating material such as glass or acrylic resin.

A decorative printing portion 41 is provided on a peripheral part of the protective plate 4 which is a back surface 4b facing a front surface 4a of the protective plate 4 and is positioned to face the front surface 2a of the touch panel 2. The decorative printing portion 41 is made of an organic material and suppresses light from being viewed from the front surface 4a of the protective plate 4 by light-shielding of the peripheral part of the protective plate 4.

The transparent resin 3 is disposed in a gap between the touch panel 2 and the protective plate 4 and bonds the touch panel 2 and the protective plate 4 to each other by a curing treatment. The transparent resin 3 has light translucency, remains initially in a liquid state or a gel state having a constant viscosity, and is cured by a curing treatment specific to the material as represented by ultraviolet irradiation to achieve certain hardness.

In the display device with the touch panel 100 of this disclosure, an end 2b of the touch panel 2 extends up to an end where the decorative printing portion 41 disposed on the peripheral part of the protective plate 4 is disposed. That is, the end 2b of the touch panel 2 extends such that the touch panel 2 is disposed in a region (a disposition region of the decorative printing portion 41) overlapping the decorative printing portion 41 disposed on the peripheral part of the protective plate 4 in a plan view (FIG. 1).

The housing 6 is a frame-shaped holding member that holds the display device 1 and the touch panel 2, and the touch panel 2 is fixed to an upper surface 6a facing the peripheral part of the back surface 2c.

In addition, by the bonding member 5 disposed as illustrated in FIG. 2, the display device 1 and the touch panel 2 are fixed to each other, and the touch panel 2 and the housing 6 are fixed to each other. An example of the bonding member 5 may include an adhesive member made of a material such as resin or a double-sided tape in which an adhesive material is disposed on both sides of a base. The bonding member 5 is disposed in the region of the back surface 2c of the touch panel 2 overlapping the decorative printing portion 41. Further, the bonding members 5 are separately arranged to fix the display device 1 and the touch panel 2 to each other and fix the touch panel 2 and the housing 6 to each other.

The end 2b of the touch panel 2 is formed to extend such that the touch panel 2 is disposed in the region overlapping the decorative printing portion 41 formed on the peripheral part of the protective plate 4, the bonding member 5 is disposed on the back surface 2c of the touch panel 2. Thereby, a the display device 1 and the touch panel 2 are bonded to each other and the touch panel 2 and the housing 6 are bonded to each other by the bonding member 5. That is, the protective plate 4 is bonded to the display device 1 and the housing 6 through the touch panel 2 by the bonding member 5 at the peripheral part on which the decorative printing portion 41 is provided.

As described above, since the bonding member 5 is disposed through the touch panel 2, even when the decorative printing portion 41 is deteriorated due to long-term exposure to ultraviolet light or the like of the display device with the touch panel 100 according to this disclosure out of doors, the bonding member 5 is suppressed from being affected by the deterioration of the decorative printing portion 41. Accordingly, it is possible to achieve long-term bonding strength between the protective plate 4 and the display device 1 or the housing 6.

Further, it is possible to suppress the peeling of the bonding member 5 to be caused by the deterioration of the decorative printing portion 41, and it is possible to prevent the touch panel 2 and the protective plate 4 from falling off from the display device 1 or the housing 6 in the structure according to this embodiment.

Since the bonding surface of the bonding member 5 is the back surface 2c of the touch panel 2 and is a smooth surface, the bonding member 5 does not pass through the decorative printing portion 41. Accordingly, as compared with a case where the bonding member 5 is disposed on the decorative printing portion 41, it is possible to increase the bonding strength. Therefore, the bonding area of the bonding member 5 can be narrowed as compared with the related art, and thus it is possible to obtain the display device with the touch panel 100 with a narrow frame.

Since the bonding member 5 is separately disposed on the display device 1 and the housing 6, even when the display surface 1a of the display device 1 and the upper surface 6a of the housing 6 do not coincide in height with each other, this can be dealt with by changing in thickness of the bonding member 5, and the housing can be freely designed.

FIG. 3 is a cross-sectional view of a display device with a touch panel according to a modified example. The bonding member 5 is separately disposed on the display device 1 and the housing 6 in the display device with the touch panel 100 illustrated in FIG. 2, but a bonding member 5 may be disposed across a display device 1 and a housing 6 as illustrated in FIG. 3. With this configuration, the bonding member 5 is not separated, and thus a touch panel 2 can be easily attached to the housing 6 and the display device 1.

In addition, since the bonding member 5 for fixing the display device 1 and the touch panel 2 to each other and the bonding member 5 for fixing the touch panel 2 and the housing 6 to each other are integrated with each other, it is possible to reduce the number of parts and to reduce assembling work, thereby reducing production costs.

This disclosure is not limited to the above-described examples, and various modifications and changes can be naturally made in the material composition, disposition position, and the like without departing from the scope of this disclosure.

What is claimed is:

1. A display device with a touch panel comprising:
a display device that has a display surface on which an image is displayed;
a touch panel that is disposed at a position corresponding to the display surface;
a protective plate that has light translucency and is provided with a printing portion at a peripheral part thereof to protect the touch panel; and
a transparent resin that has light translucency and is disposed in a gap between the touch panel and the protective plate to bond the touch panel and the protective plate to each other,
wherein the touch panel extends to a position overlapping the printing portion of the protective plate in plan view, and includes a bonding member that fixes the display device and the touch panel to each other at a position overlapping the printing portion.

2. A display device with a touch panel comprising:
a display device that has a display surface on which an image is displayed;
a touch panel that is disposed at a position corresponding to the display surface;
a protective plate that has light translucency and is provided with a printing portion at a peripheral part thereof to protect the touch panel;
a transparent resin that has light translucency and is disposed in a gap between the touch panel and the protective plate to bond the touch panel and the protective plate to each other; and
a frame-shaped housing that holds the display device and the touch panel,
wherein the touch panel extends to a position overlapping the printing portion of the protective plate in plan view, and includes a bonding member that fixes the frame-shaped housing and the touch panel to each other at a position overlapping the printing portion.

3. A display device with a touch panel comprising:
a display device that has a display surface on which an image is displayed;
a touch panel that is disposed at a position corresponding to the display surface;
a protective plate that has light translucency and is provided with a printing portion at a peripheral part thereof to protect the touch panel;
a transparent resin that has light translucency and is disposed in a gap between the touch panel and the protective plate to bond the touch panel and the protective plate to each other; and
a frame-shaped housing that holds the display device and the touch panel,
wherein the touch panel extends to a position overlapping the printing portion of the protective plate in plan view, and includes a bonding member that fixes the display device and the touch panel to each other and fixes the frame-shaped housing and the touch panel to each other at a position overlapping the printing portion.

4. The display device with the touch panel according to claim 3,
wherein at least two of the bonding member is separately disposed in cross-sectional view to fix the display device and the touch panel and to fix the touch panel and the frame-shaped housing, respectively.

5. The display device with the touch panel according to claim 3,
wherein the bonding member is disposed across the frame-shaped housing and the display device in cross-sectional view to fix the bonding member is provided across the display device and the touch panel and to fix the touch panel and the frame-shaped housing.
